(19) United States
(12) Patent Application Publication
(10) Pub. No.: US 2005/0210259 A1
(43) Pub. Date: Sep. 22, 2005

(54) Scan to confidential print job communications

(75) Inventor: Tanna Marie Richardson, Happy Valley, OR (US)

Correspondence Address: Gerald W. Maliszewski, P.O. Box 270829, San Diego, CA, 92198-2829, US

(73) Assignee: Sharp Laboratories of America, Inc.

(21) Appl. No.: 10/805,761

(22) Filed: Mar. 22, 2004

(51) Int. Cl. H04L 9/00

(52) U.S. Cl. 713/179

(57) ABSTRACT

A system and method are provided for scan to confidential print job communications. The method comprises: at a source, scanning a document; accepting a password; encrypting the scanned document; transmitting the encrypted document with the password, to a network-connected printer; at the printer, accepting the encrypted document and password; accepting an access code at a local interface; comparing the access code to the password; in response to a matching the access code to the password, decrypting the document; and, printing the decrypted document. More specifically, an encryption key is derived from the password as used to encrypt the document, and the source hashes the password. Then, the encrypted document is transmitted with the hashed password. Likewise, the printer hashes the access code; compares the hashed password to the hashed access code; regenerates the encryption key from the access code; and, uses the encryption key to decrypt the encrypted document.

### BACKGROUND OF THE INVENTION

1. Field of the Invention

This invention generally relates to-secure communications and digital imaging and, more particularly, to a system and method for confidentially communicating “Scan to Print” jobs.

2. Description of the Related Art

Multifunctional peripherals (MFP's), copiers, printers, scanners, fax machines, and other digital imaging processing equipment, often have a network scanning function that permits a user to scan paper documents, and send them electronically to e-mail recipients, network folders, FTP servers, and other printers on the network. Generally, this type of communication is known as scan to . . . technology. Scan to print enables users to scan a document on one MFP and print it out at another location. This functionality is similar to the fax paradigm, but without long distance charges, because Internet technology is used.

FIG. 1 is a diagram illustrating the scan to print methodology (prior art). One problem with this conventional paradigm is that the electronic document received by the target printer is immediately output to paper upon receipt. The immediate printing permits confidential documents could be picked up at the printer by an unintended recipient.

The only direct solution currently available for this problem is for the recipient to wait at the device for the incoming document. This is obviously undesirable, as the sender and receiver may be in different time zones or have conflicting schedules.

Alternatively, the document can be sent using another transfer method such as fax, scan to e-mail, or scan to folder, and then have the recipient manually print the document. However, fax is cost-inhibitive, and scan to e-mail or scan to folder may not be possible in environments where workers do not have access to a computer, such as in a warehouse.

Another problem with the conventional paradigm is that the electronic documents are transferred between MFP's in clear-text. Thus, the communications can be intercepted and read during transfer.

It would be advantageous if a means existed for confidentially enabling scan to print communications.

It would be advantageous if scan to print communications could be encrypted for security, and only printed when the recipient enabled the target printer.

### SUMMARY OF THE INVENTION

The present invention combines three concepts into a new method of network scanning. The first concept, “scan to print,” enables a user to scan a paper document on one device, which is converted into electronic format, transferred via Internet protocols, and printed out on another device (see FIG. 1). The second concept concerns “confidential print”, where a user selects a “confidential print” option and enters a secret PIN number to send along with the print job. When the document is transferred to the printer, it is held in printer memory until the user enters this same PIN number at the front panel. If the PIN numbers match, the job is printed. The third concept, “print encryption,” allows a document to be sent to the printer in an encrypted format so that data “sniffed” on the network cannot be read.

The present invention combines the three above-mentioned concepts to form a new paradigm, “scan to confidential print”. Users scan a document at one device and enter a PIN number to be associated with the document. The document is then encrypted and transferred to the target device and held in memory until the recipient enters the same PIN number at the receiving device's front panel. The document is then decrypted and printed. This invention ensures that the document is safe from the time it is scanned at one device, until it is printed by the intended recipient at the target device.

Accordingly, a method is provided for scan to confidential print job communications. The method comprises: at a source, scanning a document; accepting a password; encrypting the scanned document; transmitting the encrypted document with the password, from the source to a network-connected printer; at the printer, accepting the encrypted document and password; accepting an access code at a local interface; comparing the access code to the password; in response to a matching the access code to the password, decrypting the document; and, printing the decrypted document.

More specifically, encrypting the document includes: at the source, deriving an encryption key from the password; and, using the encryption key to encrypt the document. Further, the source hashes the password. Then, transmitting the encrypted document to a network-connected printer, with the password, includes transmitting the encrypted document with the hashed password.

Likewise, the method further comprises: at the printer, hashing the access code. Then, comparing the access code to the password includes comparing the hashed password to the hashed access code. Decrypting the document includes: regenerating the encryption key from the access code; and, using the encryption key to decrypt the encrypted document.

Additional details of the above-described method and a system for scan to confidential print communications are provided below.

### BRIEF DESCRIPTION OF THE DRAWINGS

FIG. 1 is a diagram illustrating the scan to print methodology (prior art).

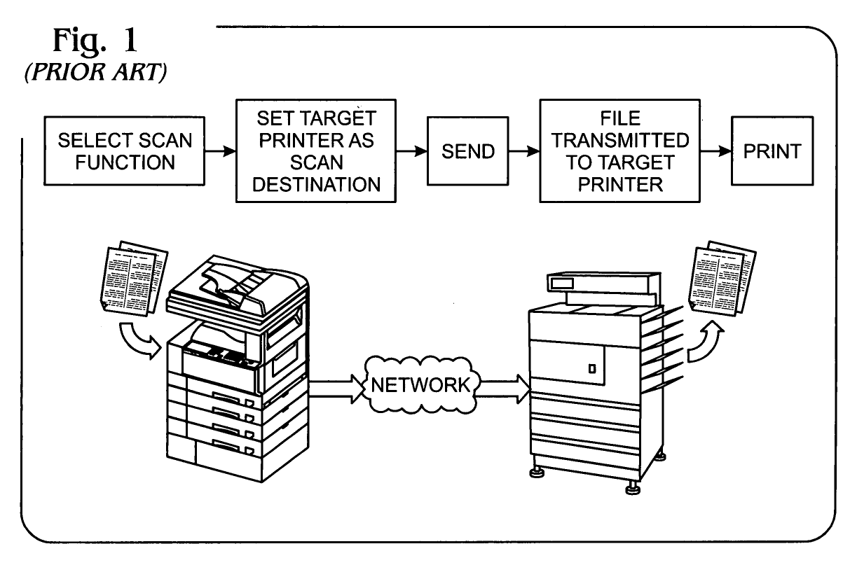

FIG. 2 is a schematic block diagram of the present invention scan to confidential print job communications system.

FIG. 3 is a depiction of the present invention scan to confidential print process.

FIG. 4 is a flowchart illustrating the present invention method for scan to confidential print job communications.

FIG. 5 is a flowchart illustrating the present invention method for recovering scan to confidential print communications.

### DETAILED DESCRIPTION OF THE PREFERRED EMBODIMENTS

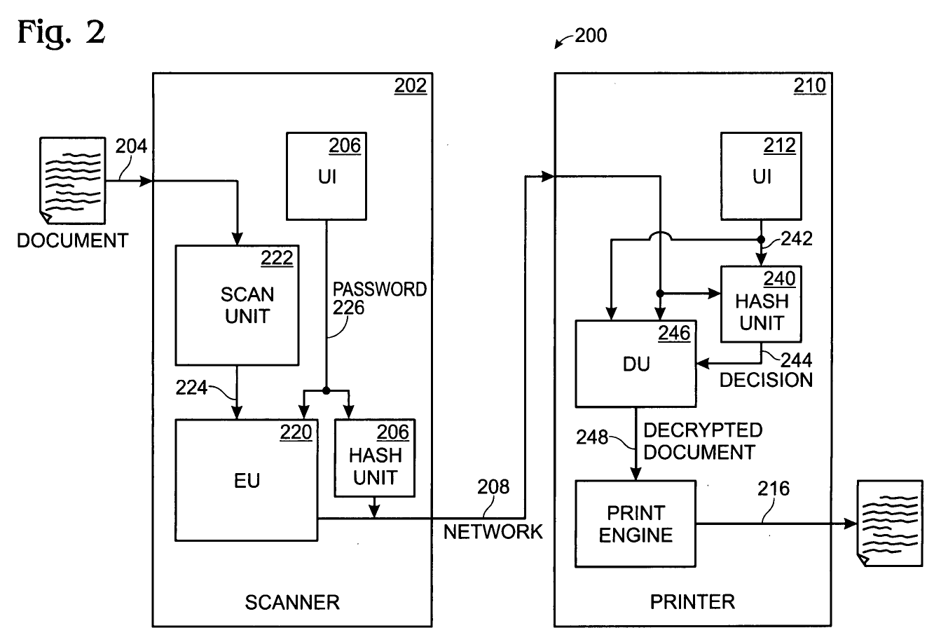

FIG. 2 is a schematic block diagram of the present invention scan to confidential print job communications system. The system 200 comprises a scanner 202 having an input on line 204 to accept a paper media document and a user interface (UI) 206 to accept a password. The scanner 202 can be any type of imaging device that has a scanning function. The scanner 202 scans the document, encrypts the scanned document, and transmits the encrypted document, with the password, on a network-connected output on line 208.

A printer 210 has a network-connected input on line 208 to accept the encrypted document and password. A printer is any device that is capable of rending a printed document from electronic data received via a network. Further, a network can be a local network, a local area network, or an Internet connection, to name a few examples. The printer 210 has a user interface 212 to accept an access code. The printer 210 compares the access code to the password, and in response to a matching the access code to the password, decrypts the document. The printer 210 has a print engine 214 to supply a printed copy of the decrypted document at an output on line 216.

The scanner user interface 206 is a mechanism that accepts a password such as a PIN number or alphanumeric code, in which case the interface 206 might be a keypad. Alternately, the interface 206 can be a mechanism to read biometric data. Further, the interface can be a mechanism to read a Smart card, magnetic stripe card, or proximity badge. Other identification means are known to those skilled in the art. The printer user interface 212 can, likewise, be any of the above-mentioned mechanisms. In a general aspect of the system, the password and access code need not necessarily exactly match. For example, the printer 210 can cross-reference a password to a thumbprint, so that the document sender need not necessarily be the recipient. However, in other aspects presented below, the password and access code need to identically match because of a hashing process.

In some aspect, the scanner 202 includes an encryption unit (EU) 220 having an input on line 208 to accept the scanned document from a scan unit 222 on line 224, and an input on line 226 to accept the password. The encryption unit 220 derives an encryption key from the password and uses the encryption key to supply the encrypted document at an output on line 208. The scanner 202 further includes a hash unit 230 having an input on line 226 to accept the password and an output on line 208 to supply a hashed password. The scanner 202 transmits the encrypted document with the hashed password on line 208.

For example, the scanner 202 may transmit a file with an unencrypted header that includes an identification of the scanned document and the hashed password. The file also includes encrypted document data (the encrypted document).

The printer 210, then, includes a hash unit 240 with an input on line 242 to accept the access code and an input on line 208 to accept the hashed codeword. The hash unit 240 generates a hashed access code and supplies a decision at an output on line 244 in response to comparing the hashed password to the hashed access code. For example, the decision can be a signal that is interpreted to mean that it is permissible to decrypt the document, because the hashed codeword matches the hashed access code.

In some aspects, the printer 210 further includes a decryption unit (DU) 246 having an input on line 244 to accept the decision from the printer hash unit 240. The decryption unit 246 has an input on line 208 to accept the encrypted document and an input on line 242 to accept the access code. The decryption unit 246 regenerates the encryption key from the access code and uses the encryption key to supply the decrypted document at an output on line 248, connected to the print engine 214.

### Functional Description

Users desire the ability to scan a document at one device and print it out at another network printer. There is also a big push for security features. For example, new legislation such as HIPAA for the medical industry heightens security concerns. One of the biggest MFP-related concerns for these users is the likelihood of confidential documents sitting unattended in printer output trays.

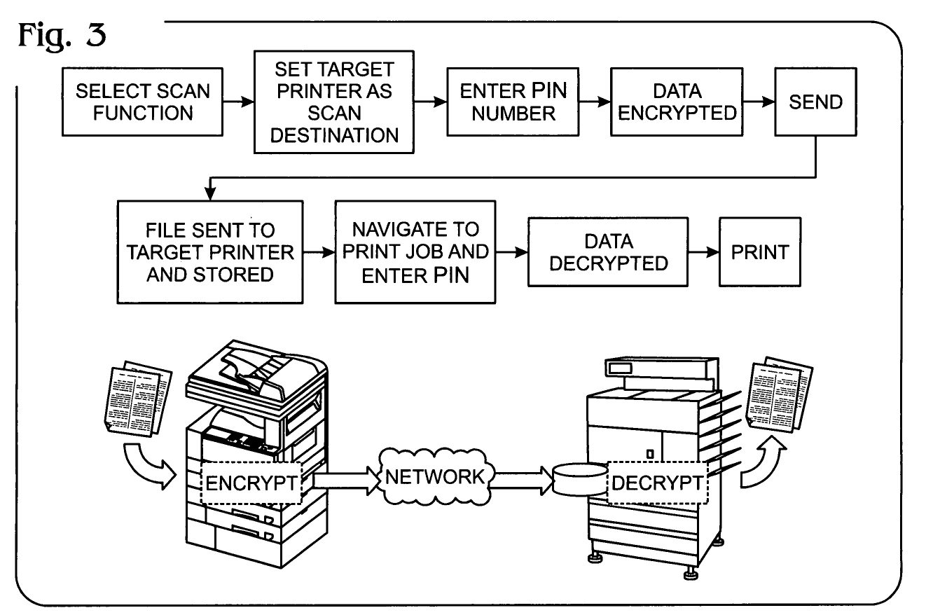

FIG. 3 is a depiction of the present invention scan to confidential print process. The present invention was developed as a response to the above-mentioned concerns. A user places a document to be scanned in MFP-A and, then navigates through the control panel to specify scan settings. The user selects a scan destination (MFP-B) and enters a PIN number to associate with the document. The user then presses START to scan the document.

The document is scanned and encrypted by MFP-A and transferred to MFP-B. MFP-B receives the document and stores it in memory. At some later time, the recipient navigates the control panel at MFP-B to select the stored document and enters the required PIN number. If the PIN matches, the device decrypts and prints the stored document. In alternative aspects, the PIN number can also be an alphanumeric password, a thumbprint, or any other form of secret key.

For example, the MD5 algorithm can be used to perform the hashing, while the RC4 algorithm can be used to perform the encryption. However, other algorithms are known in the art that can perform the same functions. Only the data in the scanned file is encrypted, using RC4. An encryption key is also derived from the user-entered password. The file header can be sent in clear-text with a hash of the user's password and applicable permissions. The permissions allow a user to read, copy, print, or modify the document on the target printer.

When the file is received at the target device, the user enters an access code on the front panel. This password is hashed and compared to the hashed codeword in the file header. If there is a match, the printer checks the permissions flags to make sure print is enabled. If it is, the password can be used to regenerate the encryption key and decrypt the data in the file for printing.

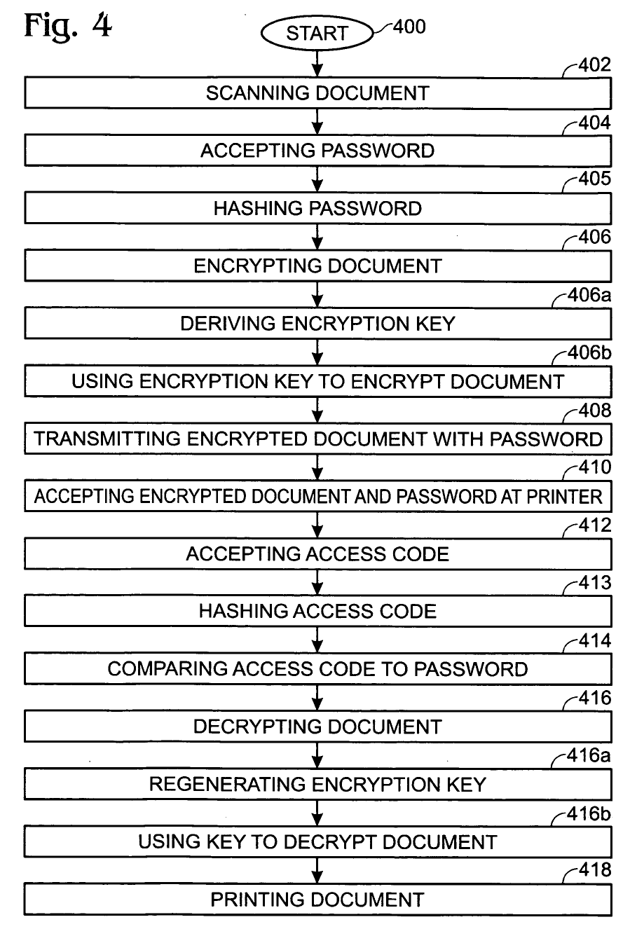

FIG. 4 is a flowchart illustrating the present invention method for scan to confidential print job communications. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 400.

Step 402 scans a document at a source. Step 404 accepts a password. Step 406 encrypts the scanned document. Step 408 transmits the encrypted document with the password, from the source to a network-connected printer. Step 410 accepts the encrypted document and password at the printer. Step 412 accepts an access code at a local interface. Step 414 compares the access code to the password. Step 416 decrypts the document in response to a matching the access code to the password. Step 418 prints the decrypted document.

In one aspect, accepting a password in Step 404 includes accepting a password such as a PIN number, an alphanumeric code, biometric data, Smart card, magnetic stripe card, or proximity badge. This same analysis applies to the access code of Step 412.

In another aspect, encrypting the document in Step 406 includes substeps. Step 406a derives an encryption key from the password (at the source), and Step 406b uses the encryption key to encrypt the document.

In a different aspect, Step 405 hashes the password. Then, transmitting the encrypted document to a network-connected printer, with the password, in Step 408, more specifically means that the hashed password is transmitted with the encrypted document. For example, Step 408 may transmit a file including an unencrypted header with an identification of the scanned document, and the hashed password, along with encrypted document data.

Likewise, Step 413 (at the printer) hashes the access code. Then, comparing the access code to the password in Step 414 includes comparing the hashed password to the hashed access code. In one aspect, decrypting the document in Step 416 includes substeps. Step 416a regenerates the encryption key from the access code. Step 416b uses the encryption key to decrypt the encrypted document.

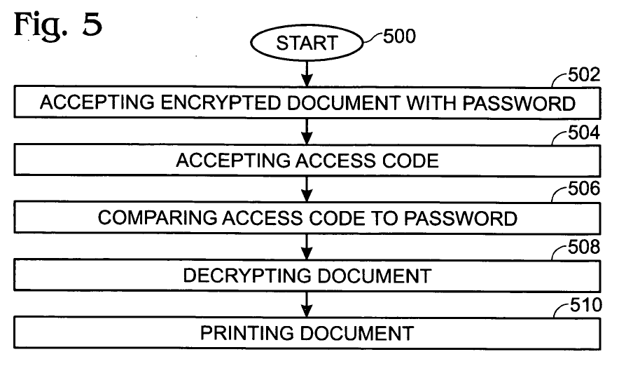

FIG. 5 is a flowchart illustrating the present invention method for recovering scan to confidential print communications. The method starts at Step 500. Step 502 accepts an encrypted document and password at a network-connected printer interface. Step 504 accepts an access code at a local interface. Step 506 compares the access code to the password. Step 508, in response to a matching the access code to the password, decrypts the document. Step 510 prints the decrypted document. Additional details of this method can be found in the explanation of Steps 410 through 418 of FIG. 4, above.

A system and method for scan to confidential print job communications has been provided. Examples have been given to illustrate and clarify, but the invention is not limited to just these examples. Neither is the invention limited to any particular encryption or hashing scheme. Other variations and embodiments of the invention will occur to those skilled in the art.

1. A method for scan to confidential print job communications, the method comprising:
at a source, scanning a document;
accepting a password;
encrypting the scanned document; and,
transmitting the encrypted document with the password, from the source to a network-connected printer.

2. The method of claim 1 further comprising:
at the printer, accepting the encrypted document and password;
accepting an access code at a local interface;
comparing the access code to the password;
in response to a matching the access code to the password, decrypting the document; and,
printing the decrypted document.

3. The method of claim 1 wherein accepting a password includes accepting a password selected from the group including a PIN number, an alphanumeric code, biometric data, Smart card, magnetic stripe card, and proximity badge.

4. The method of claim 2 wherein encrypting the document includes:
at the source, deriving an encryption key from the password; and,
using the encryption key to encrypt the document.

5. The method of claim 4 further comprising:
hashing the password; and,
wherein transmitting the encrypted document to a network-connected printer, with the password, includes transmitting the encrypted document with the hashed password.

6. The method of claim 5 wherein transmitting the encrypted document with the hashed password includes transmitting a file including:
an unencrypted header with an identification of the scanned document and the hashed password; and,
encrypted document data.

7. The method of claim 5 further comprising:
at the printer, hashing the access code; and,
wherein comparing the access code to the password includes comparing the hashed password to the hashed access code.

8. The method of claim 7 wherein decrypting the document includes:
regenerating the encryption key from the access code; and,
using the encryption key to decrypt the encrypted document.

9. A method for recovering scan to confidential print communications, the method comprising:
at a network-connected printer interface, accepting an encrypted document and password;
accepting an access code at a local interface;
comparing the access code to the password;
in response to a matching the access code to the password, decrypting the document; and,
printing the decrypted document.

10. A scan to confidential print job communications system, the system comprising:
a scanner having an input to accept a paper media document and a user interface to accept a password, the scanner scanning the document, encrypting the scanned document, and transmitting the encrypted document with the password, on a network-connected output.

11. The system of claim 10 further comprising:
a printer having a network-connected input to accept the encrypted document and password, and a user interface to accept an access code, the printer comparing the access code to the password, and in response to a matching the access code to the password, decrypting the document, the printer having an output to supply a printed copy of the decrypted document.

12. The system of claim 10 wherein the scanner user interface accepts a password selected from the group including a PIN number, an alphanumeric code, biometric data, Smart card, magnetic stripe card, and proximity badge.

13. The system of claim 11 wherein the scanner includes an encryption unit having an input to accept the scanned document and an input to accept the password, the encryption unit deriving an encryption key from the password and using the encryption key to supply the encrypted document at an output.

14. The system of claim 13 wherein the scanner further includes a hash unit having an input to accept the password and an output to supply a hashed password; and,
wherein the scanner transmits the encrypted document with the hashed password.

15. The system of claim 14 wherein the scanner transmits a file with an unencrypted header including an identification of the scanned document and the hashed password, and encrypted document data.

16. The system of claim 14 wherein the printer includes a hash unit with an input to accept the access code and an input to accept the hashed codeword, the hash unit generating a hashed access code and supplying a decision at an output in response to comparing the hashed password to the hashed access code.

17. The system of claim 16 wherein the printer further includes a decryption unit having an input to accept the decision from the printer hash unit, an input to accept the encrypted document, and an input to accept the access code, the decryption unit regenerating the encryption key from the access code and using the encryption key to supply the decrypted document at an output.

18. The system of claim 11 wherein the printer user interface accepts an access code selected from the group including a PIN number, an alphanumeric code, biometric data, Smart card, magnetic stripe card, and proximity badge.

19. A system for recovering scan to confidential print communications, the system comprising:
a printer having a network-connected input to accept an encrypted document and password, and a user interface to accept an access code at a local interface, the printer comparing the access code to the password, and in response to a matching the access code to the password, decrypting the document, the printer having an output to supply a printed copy of the decrypted document.
